(19) United States
(12) Patent Application Publication
(10) Pub. No.: US 2003/0208537 A1
(43) Pub. Date: Nov. 6, 2003

(54) Real-time data collection and distribution among office productivity software applications

(76) Inventors: James K. Lane, State College, PA (US); Richard A. Rivell, State College, PA (US); Sven D. Olsen, State College, PA (US)

Correspondence Address: MOSER, PATTERSON & SHERIDAN, LLP, 595 SHREWSBURY AVENUE, SUITE 100, SHREWSBURY, NJ, 07702, US

(21) Appl. No.: 10/136,192

(22) Filed: May 1, 2002

(51) Int. Cl. G06F 15/16

(52) U.S. Cl. 709/204

(57) ABSTRACT

A method of facilitating real-time data distribution and collection among office productivity software applications running on each of a plurality of source and destination processors. The source and destination processors communicate over a distributed data processing network through a real-time data server. Data related to a specific topic is received by the real-time data server from the office productivity software processing application running on one or more of the source processors. The data is disseminated in real-time, via the real-time server, to the office productivity software application running on each of the destination processors.

### FIELD OF THE INVENTION

The invention relates generally to real-time data collection and distribution and, more specifically, to real-time data collection and distribution among office productivity software processing applications.

### BACKGROUND OF THE INVENTION

Real-time data distribution and collection is used in many large-scale scientific and engineering systems. Real-time data distribution and collection involves the dissemination of data from source processors that provide data to destination processors that use the data to provide, for example, real-time system performance updates and control. These systems typically collect data in real-time using multiple collectors (or sources), route the collected data to processors for processing, and record both the collected and processed data for later analysis. Data movement between collectors and processors is an important issue when providing real-time data collection and distribution functionality in a system. Fiscal constraints of providing real-time data collection and distribution can restrict the number of collectors and processors included in the system, and thus limit the amount of data collected in real-time.

Legacy real-time data collection and distribution systems, often used in a mission-management context, typically have been coded using languages such as FORTRAN and PASCAL and result in systems having from one million to five million lines of code (LOC). More recently, real-time data distribution and collection systems have been coded using object-orientated programming techniques with languages such as C++ and JAVA. These object-oriented systems typically result in such systems having from one million to five million LOC. These large-scale development tasks generally result in a variety of undesirable issues, e.g., the LOC size, the project team size, the long development cycle, the diversity of and incompatibilities among development tools, and a custom-coded domain object architecture.

The Deep Space Network used by NASA is an example of a legacy real-time data distribution and collection system. It includes a multiplicity of large-dish antennas distributed around the world, which capture signals (i.e., data) from solar system probes. Signals from a number of planetary explorers are captured each day. As such, the real-time data collection and distribution system directs the antennas to the proper position in space, configures the receivers of the antennas to the selected frequencies, routes the data to a centralized site, processes the data from multiple collectors, and records the collected and processed data. The system typically deploys resources according to a schedule that yields the most minutes of collection from the highest-priority collectors.

The earth-crossing asteroid project is another example of a legacy real-time data distribution and collection system. This system includes multiple moderate-aperture optical telescopes that scan the heavens for asteroids that may cross the earth's orbit at the wrong moment. The real-time data collection and distribution system directs the telescopes to particular patches of space, collects images, forwards them to a processing center, processes the images for near-earth objects, records the data, and optionally cues larger-aperture telescopes to investigate in detail particularly interesting objects.

Microsoft Corporation, of Redmond Wash., offers a real-time data distribution function for certain desktop spreadsheet applications. Recently, Microsoft released updated desktop data processing application suites, OFFICE 2002 (OFFICE XP). Each suite includes a spreadsheet application (i.e., EXCEL). The spreadsheet application includes a Real-Time Data (RTD) function. The RTD function is an improvement over previous spreadsheet data exchanging functionality (i.e., Dynamic Data Exchange “DDE”). Generally, the RTD function allows a cell in a worksheet of a spreadsheet application to call a Component Object Model (COM) Automation server (i.e., a real-time data server) to retrieve data in real-time. The cell is programmed using the RTD function of the spreadsheet application. The function includes a reference (e.g., an IP address) to the specific computer on which the real-time data server is running. If that server becomes disabled, the RTD function is invalid and must be updated manually by the user to refer to a functional server.

Currently, the RTD function is provided only in the spreadsheet application of the desktop data processing suite. As such, each processor and server using the RTD functionality must include a locally-running instance of the spreadsheet application. Each real-time data server is capable of providing data to a single instance of the spreadsheet application. In other words, if two instances of the spreadsheet application attempt to retrieve data from the same real-time data server, an error occurs. To overcome this limitation, it has been suggested that each instance of the RTD function reference an individual server. In such an implementation, if ten instances of the spreadsheet application expect to receive the same updated information, ten real-time data servers must be employed to provide this data to each of the ten spreadsheet instances. For larger systems, this prohibitively increases the computational requirements, dramatically slows the system performance, and increases complexity.

### SUMMARY OF THE INVENTION

Accordingly, there exists a need for a real-time data collection and distribution system that leverages the functionality of a desktop application suite and is suitable for use in large-scale scientific and engineering applications. Also, there exists a need for a real-time data server capable of receiving input data from any number of applications of a desktop data processing application suite and providing the received data to any number applications of desktop data processing application suite.

In one aspect, the invention relates to a method of facilitating real-time data distribution and collection among office productivity software applications running on each of a plurality of source and destination processors. The source and sink processors communicate over a distributed data processing network through a real-time server. The method includes the steps of receiving, at the real-time server, data related to a first topic from the office productivity software processing application running on one or more of the source processors, and disseminating in real-time, via the first real-time server, data related to the first topic to the office productivity software application running on each of the destination processors.

In one embodiment, the real-time server queues the data related to the first topic. The data may be retrieved from the real-time data server by the destination processors, or may be sent to the destination processors by the real-time data server. The real-time data server runs on a host dynamically selected from a plurality of processors. The host may be chosen based on the processing load of all the hosts. Alternatively, the host may be chosen in a round-robin fashion.

The office productivity software applications may include an application selected from the group consisting of a spreadsheet application, a database application, and a word processing application. In one embodiment, these applications may be part of a commercial office-the-shelf office productivity suite such as OFFICE XP (OFFICE 2002) or WORD PERFECT OFFICE SUITE 2002.

In another aspect, the invention relates to a method of facilitating real-time data distribution and collection among office productivity software applications running on each of a plurality of processors communicating over a distributed data processing network. The method includes the steps of receiving a request for a reference identifier of a real-time data server dedicated to a first topic from a first processor, initiating the real-time data server on a host processor for the first topic, and receiving a request for a reference identifier of a real-time server dedicated to a second topic from a second processor.

Additionally, the method includes the steps of comparing the request for a reference identifier of a real-time data server dedicated to the first topic to the request for a reference identifier of a real-time data server dedicated to the second topic, and facilitating communication of data related to the first topic between the first processor and second processor via the real-time data server dedicated to the first topic when the second topic corresponds to the first topic.

In yet another aspect, the invention relates to a method of facilitating real-time data distribution and collection among a plurality of processors communicating over a distributed data processing network. The method includes the step of initializing a real-time server dedicated to a specified topic on a dynamically-determined host processor. The initiation occurs in response to a request for a reference identifier of the real-time server. The real-time server facilitates data collection and distribution between an office productivity software application running on each of a plurality of source and destination processors.

The method also includes the steps of transmitting an identifier of the dynamically-determined host processor to each source and destination processor requesting to send or receive data related to the specified topic, receiving data related to the specified topic at the real-time server transmitted by the source processors, notifying each of the destination processors that requested to receive data related to the specified topic that data has been received by the real-time server, and disseminating data from the real-time server to each of the destination processors that requested to receive the data related to the specified topic.

The present invention is not necessarily limited to office productivity software applications, but can be applied to any commercial off-the-shelf software applications or custom software applications. In such an aspect, the invention relates to a method of facilitating real-time data distribution and collection among software applications communicating over a distributed data processing network through a real-time server. The method includes the steps of receiving, at the real-time server, data related to a first topic from one or more of the software applications, and disseminating in real-time, via the first real-time server, data related to the first topic to one or more software applications. The software applications may be running one or more source and sink processors throughout the distributed data processing network.

### BRIEF DESCRIPTION OF THE DRAWINGS

The invention is pointed out with particularity in the appended claims. The advantages of the invention may be better understood by referring to the following description taken in conjunction with the accompanying drawing in which:

FIG. 1 is a block diagram depicting an embodiment of a real-time data distribution and collection system constructed in accordance with the principles of the invention;

FIG. 2 is a block diagram depicting an embodiment of a real-time data distribution and collection system constructed in accordance with the principles of the invention;

FIG. 3 is a flow chart depicting an embodiment of the initialization steps of the present invention;

FIG. 4 is a flow chart depicting the steps of data flow through a real-time data distribution and collection system constructed in accordance with the principles of the present invention;

FIG. 5 a flow chart of an embodiment of a network error recovery method of the present invention;

FIG. 6 is a flow chart of an embodiment of a server error recovery method of the present invention;

FIG. 7 is a block diagram depicting a multipoint-to-multipoint real-time data distribution and collection system constructed in accordance with the principles of the present invention;

FIG. 8 is a block diagram of an embodiment of a gathering system constructed in accordance with the principles of the present invention; and

FIGS. 9A-9F depict data flowing through a real-time data distribution and collection system constructed in accordance with the principles of the present invention.

### DETAILED DESCRIPTION OF THE INVENTION

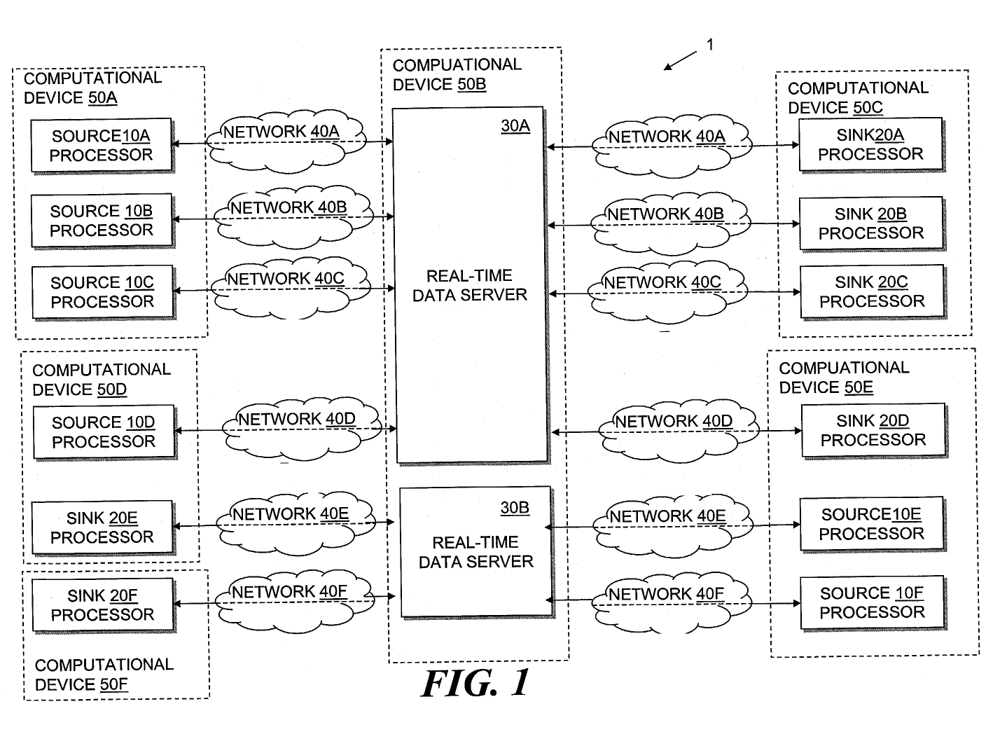

With reference to FIG. 1, a distributed data processing network 1 includes a plurality of source processors 10A, 10B, 10C, 10D, 10E, and 10F (referred to generally as source processors 10), a plurality of sink (destination) processors 20A, 20B, 20C, 20D, 20E, and 20F (referred to generally sink processors 20), and one or more real-time data servers 30A and 30B (referred to generally as real-time data servers 30). The real-time data servers 30 are in communication with the source processors 10 and sink processors 20 via communications network paths 40A, 40B, 40C, 40D, 40E, and 40F, (referred to generally as network 40). The real-time data servers 30 can be computer software embodied in a programming language, such as VISUAL BASIC, and are adapted to function with a custom real-time data function created for use with office productivity software applications (e.g., spreadsheet, word processing, database, instant messaging and electronic mail applications) or custom software applications. In some embodiments of the present invention, the real-time data servers 30 are not RTD servers currently available from MICROSOFT corporation. The network 40 may comprise one or more of the Internet, a local area network (LAN), a wide area network (WAN), a wireless network, a virtual private network (VPN), an internal data bus, or other data communications path.

As shown, the source processors 10 and sink processors 20 may be co-located on a computational device 50A or on different computation devices 50B, 50C, and 50D throughout the distributed data processing network 1, as described in detail below. Examples of computational devices 50 include, but are not limited to personal computers (desktops and laptops), personal digital assistants (PDA), and mainframe computers. The source processors 10 and sink processors 20 execute the above-described office productivity software applications. In one embodiment, the source processors 10 and sink processors 20 are workbooks of a spreadsheet application or other similar documents of the office productivity suite. In one detailed embodiment, the office productivity software applications can be part of a office productivity software suite such as OFFICE XP (OFFICE 2002) sold by MICROSOFT Corporation, or WORD PERFECT OFFICE SUITE 2002 sold by COREL Corporation of Ottawa, Ontario Canada. These office productivity software suites can include spreadsheet (EXCEL or QUATRO PRO), word processing (WORD or WORD PERFECT), database, instant messaging, and electronic mail applications. In this embodiment, the source and sink processors and the real-time data servers are configured to use a custom (i.e., user defined) function, which is part of the real-time data distribution and collection system of the present invention.

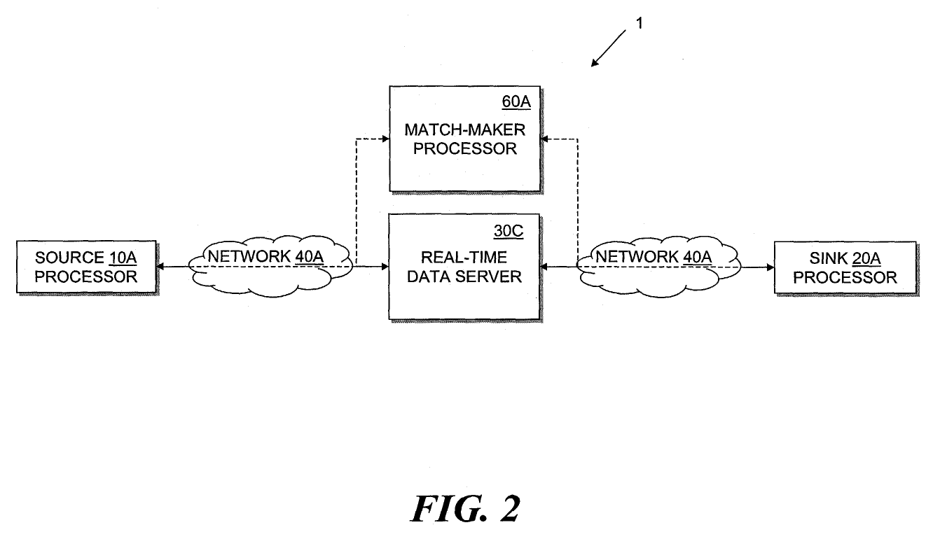

With reference to FIG. 2, the distributed data processing network 1 employs a match-maker processor 60 to establish the communications paths among the source processor 10A, the sink processor 20A and the real-time data server 30C that facilitate real-time data collection and distribution. In one embodiment, the match-maker processor 60 is computer software embodied in a programming language, such as VISUAL BASIC, that runs on any one of the computational devices 50. As shown, the match-maker processor 60 can communicate with the source processor 10A and the sink processor 20A over a network 40A. The source processor 10A and the sink processor 20A each inform the match-maker processor 60 that it wishes to receive a reference identifier of a real-time data server dedicated to a specific topic. As explained in detail below, the match-maker processor 60 establishes a real-time data server 30C for the specific topic in response to the first request it receives. Thereafter, the source processor 10A and the sink processor 20A exchange data related to the specific topic through the real-time data server 30C, as described in more detail below.

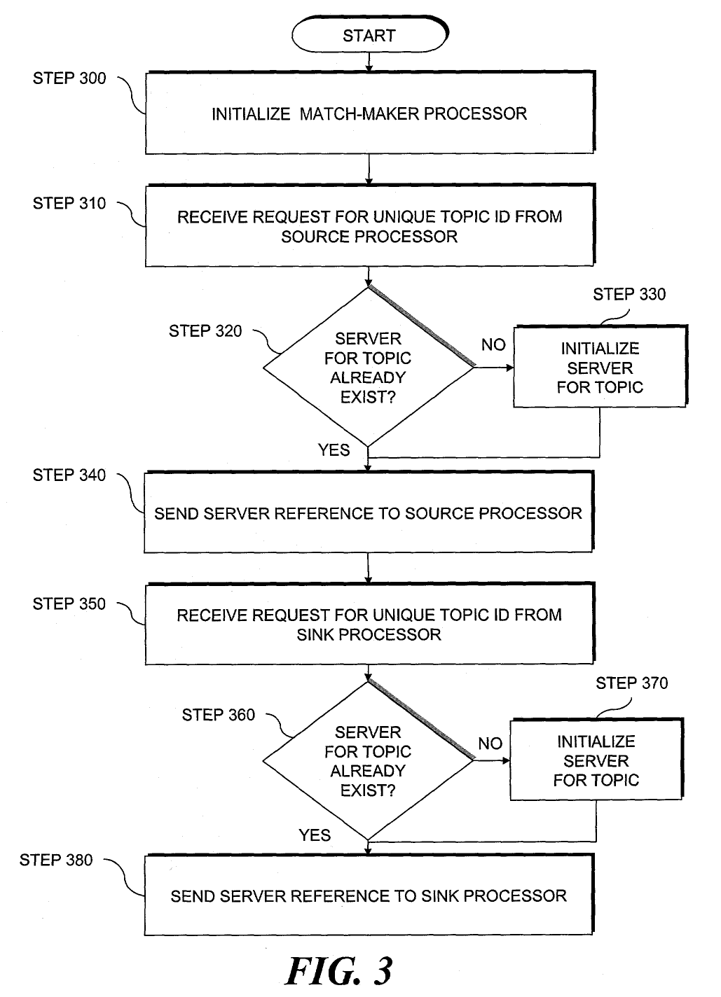

With reference to FIG. 3, in operation, a system user or administrator initiates the match-maker processor on a host computational device (STEP 300). Subsequently, the source processor submits a request to receive a reference identifier (e.g., a unique numerical string) of a real-time data server dedicated to a specific topic through the network to the match-maker processor (STEP 310). The match-maker processor determines if a real-time data server for the specific topic identifier already exists (STEP 320). If a real-time data server does not already exist for the specific topic, the match-maker processor initiates a real-time data server on a host computational device (STEP 330). The initialization of the real-time data server may be accomplished using any one of a number of techniques. For example, an executable file that includes the server code can be downloaded to the host computational device. Alternatively, the server code is already stored on the host computational device and the code is executed to initiate an instance of the real-time data server. In one embodiment, prior to initializing the real-time data server, the match-maker processor examines the processing load of each host computational device and initializes a real-time data server on the host computational device most suitable (e.g., having the lowest processing load) to mediate data transfers between the source processors and sink processors. In another embodiment, the match-maker processor sequentially initializes real-time data servers on each host computational device of the system in, for example, a round-robin fashion. Once the real-time data server for the specific topic is running, the match-maker processor returns a reference identifier (e.g., an object reference, an IP address, name, or other identifier) to the source processor (STEP 340). The source processor uses the reference identifier to provide data for the specific topic to the real-time data server.

Similarly, the match-maker processor receives a request from the sink processor for a reference identifier of a real-time data server dedicated to a specific topic (STEP 350). The match-maker processor determines if a real-time data server for the specific topic identifier already exists (STEP 360). If a real-time data server does not already exist for the specific topic, the match-maker processor initiates a real-time data server on a host computational device (STEP 370). The match-maker processor initiates the real-time server using one of the techniques described above in connection with step 330. Once the real-time data server for the topic is running, the match-maker processors returns the reference identifier (e.g., an object reference, an IP address, name, or other identifier) to the sink processor (STEP 380). The sink processor uses the reference identifier to inform the real-time data server that it desires to receive data related to the specific topic (i.e., the sink processor registers with the server). If data related to the specific topic is available, the server disseminates the data to the sink processor.

An advantage of the present is that each real-time data server is dedicated to a specific topic. As such, the number of real-time data servers increases proportionately with the number of topics of data collected and distributed by the system. As previously shown, a plurality of source processors can communicate data related to specific topic to a plurality of sink processors through a single real-time data server. Thus, the number of real-time data servers does not increase proportionately with the number of source processors and sink processors, as in other systems.

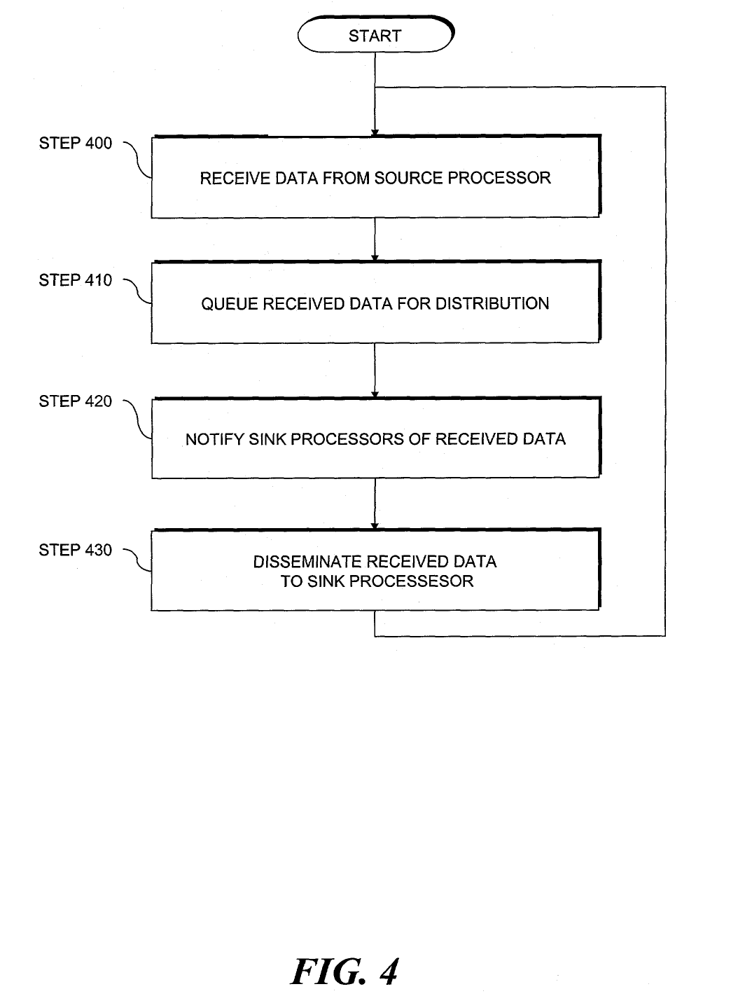

With reference to FIG. 4, a real-time data server mediates (or facilitates) the communication of data in real-time data from the source processors to the sink processors. A system user inputs new data related to a specific topic into the cell of a worksheet (or field of a word processing document) running on a source processor and executes a command that causes the data be sent to the real-time data server. The real-time data server receives the data sent by the source processor (STEP 400), and (i) queues the request to receive data from the sink processors, (ii) the received data, or (iii) both by placing the queue items in the local memory of the of the host processor (STEP 410).

After queuing, the real-time data server notifies each registered sink processor that queued data is available. In some embodiments, this notification can occur in a multicast format or by individually notifying each sink processor. After notification, the received data is disseminated to the sink processors (STEP 430). Dissemination of the received data can occur in any one of a number of ways. In one embodiment, the real-time data server can push the data (i.e., send the data) to each of the registered sink processors. In another embodiment, each of the registered sink processors acknowledges receipt of the notification and responds by retrieving the updated data from local memory of the computational device hosting the real-time data sever. The real-time data server logs, in a storage device (not shown) located on the computational device hosting the real-time data server, the transfers between the source processors and registered sink processors. One advantage of the present invention is that if a registered sink processor does not retrieve the updated data from the real-time data server, the next time the data is updated the real-time server notifies the sink processor that the data has again changed.

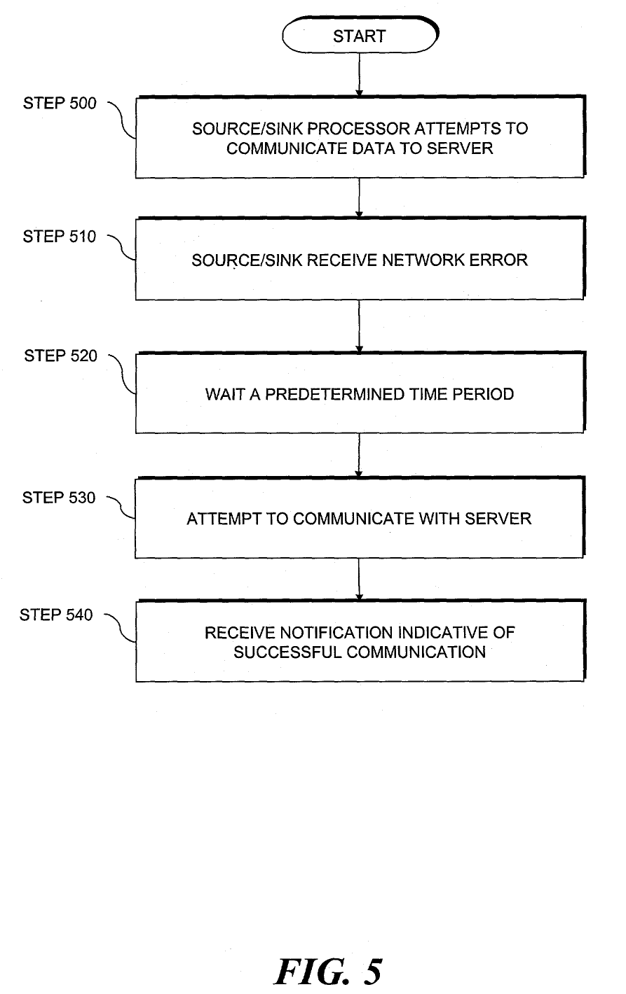

A network failure or real-time data server failure may be determined, for example, by the use of a heart-beat signal originating from the source processors, sink processors, or real-time data servers. FIG. 5 depicts the steps of an embodiment of a network error recover method employed by the source processors and sink processors in response to a network failure. In the event of a network error, communications between the source processors and/or sink processors and the real-time server cease. Each source processor and/or sink processor attempts to send data to or receive data from the real-time data server 30 (STEP 500). In response, each processor receives an error message that indicates the network failed (STEP 510). In one embodiment, a response from the real-time data server is not received, which results in the processors determining a network error has occurred. In response to the error message, each processor waits a predetermined time period (STEP 520). After the expiration of the time period, each of the processors again attempts to send data to or retrieve data from the real-time data server (STEP 530). If the network error has been corrected, the processors receive notification from the real-time data server that the data was successfully sent to or received (STEP 540). If the network has not recovered after a specific number of attempts, the source processors and sink processors communicate with a match-maker processor running on an active network to thereby establish a replacement (or new) real-time data server to facilitate real-time data collection and dissemination.

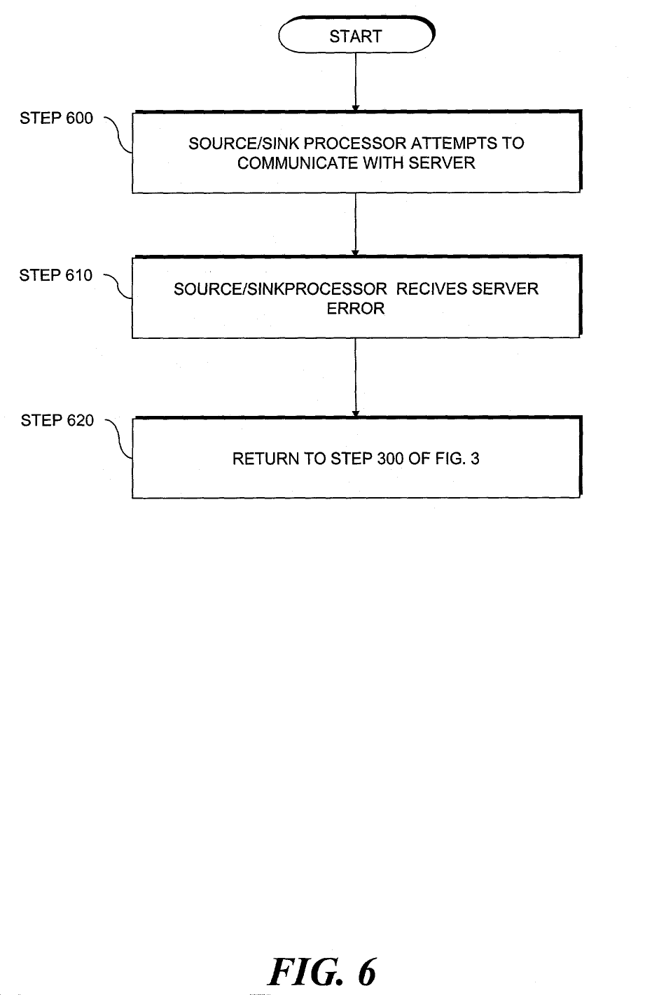

FIG. 6 depicts the steps of an embodiment of a real-time data server error recovery method. In the event that a real-time data server fails, real-time data transfers between the registered source processors and sink processors cease. The source processors and/or sink processors attempt to disseminate data via the real-time data server (STEP 600). The source processors and sink processors receive an error message (STEP 610). The error message indicates a real-time data server failed. In response, the source processors and sink processors communicate with the match-maker processor (as shown in STEP 310 and STEP 330 of FIG. 3). The match-maker processor initializes a new real-time data server for the topic of interest and communicates an identifier of a new real-time server to the source processors and sink processors. Thereafter, the source and sink processors exchange data via the new real-time data server.

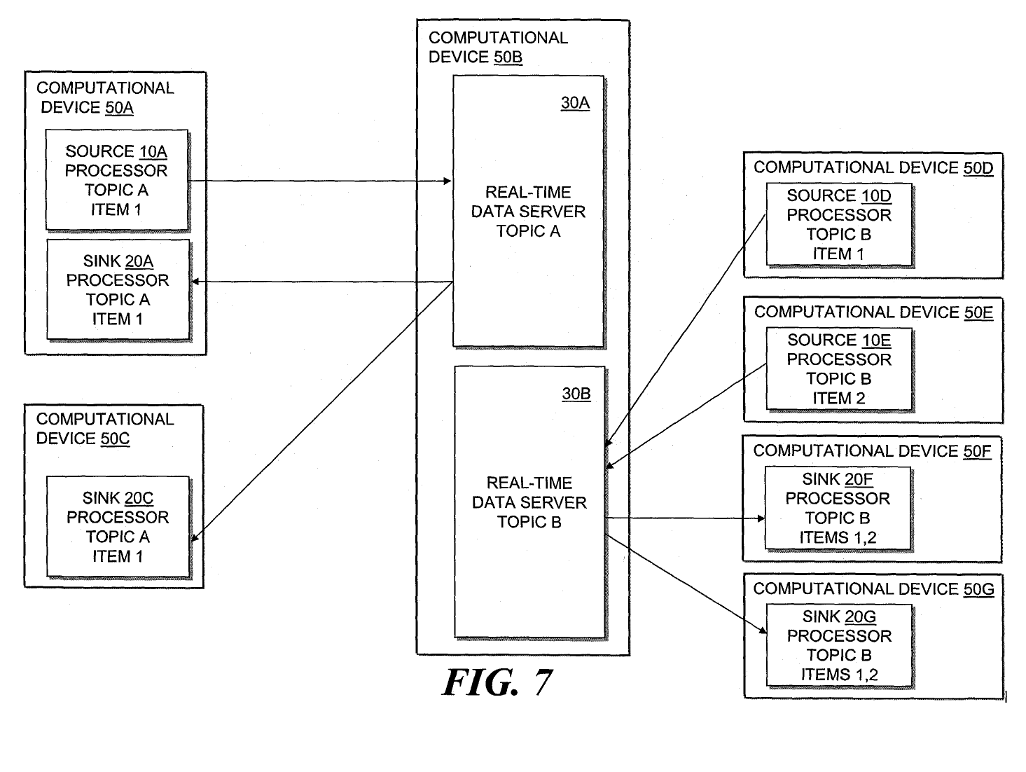

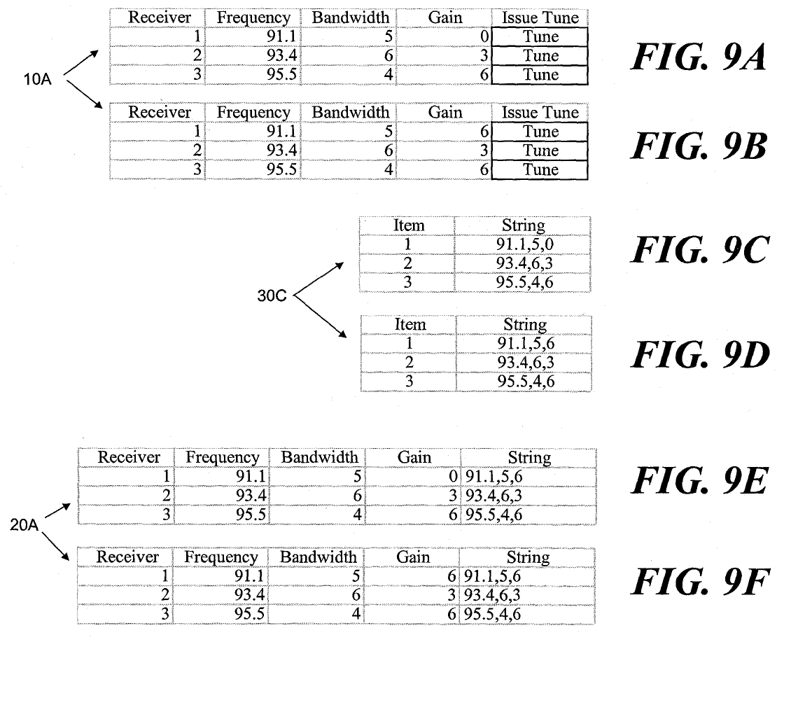

One advantage of the present system is that the system can be configured to provide point-to-point, multipoint-to-multipoint, point-to-multipoint, and multipoint-to-point real-time data collection and distribution. With reference to FIG. 7, a computational device 50A hosts a source processor 10A dedicated to providing item 1 of a topic A and a sink processor 20A dedicated to receiving item 1 of topic A. The topic may be, for example, a worksheet of an EXCEL workbook. Item 1 may be a row or a cell of the worksheet. Topics and items are described in connection with FIGS. 9A-9F below. The source processor 10A and sink processor 20A establish communications with a real-time data server 30A using a match-maker processor (not shown) as described in connection with FIGS. 2 and 3. The real-time data server 30A is hosted on a computational device 50B. As shown, point-to-point real-time data distribution and collection occurs between the source processor 10A and sink processor 10B. That is, data related to topic A, item 1 is passed from the source processor 10A to the real-time data server 30A, and in turn, to the sink processor 20A using the method described in connection with FIG. 4.

In one embodiment, a sink processor 20C subsequently registers with the real-time data server 30A. The sink processor 20C is configured to receive topic A, item 1. The sink processor 20C is referred to the real-time data server 30A by the match-maker processor. Thereafter, point-to-multipoint real-time server mediated data collection and distribution occurs between the source processor 10A and the sink processors 20A and 20C. Specifically, data related to topic A, item 1 is passed from the source processor 10A to the real-time data server 30A, and in turn, to the sink processor 20A and sink processor 20C.

A second real-time data server 30B, hosted by computational device 50B, facilitates real-time data collection and distribution of items 1 and 2 of topic B. A source processor 10D, hosted by a computational device 50D, provides item 1 of topic B to the real-time data server 30B. A source processor 10E, hosted by a computational device 50E, provides item 2 of topic B to the real-time data server 30B. A sink processor 20F is hosted on a computational device 50F. The sink processor 20F is referred to the real-time data server 30B by the match-maker processor. The sink processor 20F registers with the real-time data server 30B. The sink processor 20F is configured to receive items 1 and 2 of topic B. The data flows from multiple source processors 10D and 10E, to the real-time data server 30B, and in turn to a single sink processor 20F. As such, multiple source processors communicate data to a single sink processor 20F.

A sink processor 20G hosted by computational device 50G is referred to the real-time data server 30B by the match-maker processor. A sink processor 20G then registers with the real-time data server 30B. The sink processor 20G is configured to receive items 1 and 2 of topic B. As shown, multipoint-to-multipoint real-time server mediated data collection and distribution occurs between the source processors 10D and 10E and the sink processors 20F and 20G. The data flows from multiple source processors 10D and 10E, to the real-time data server 30B, and in turn to the sink processors 20F and 20G.

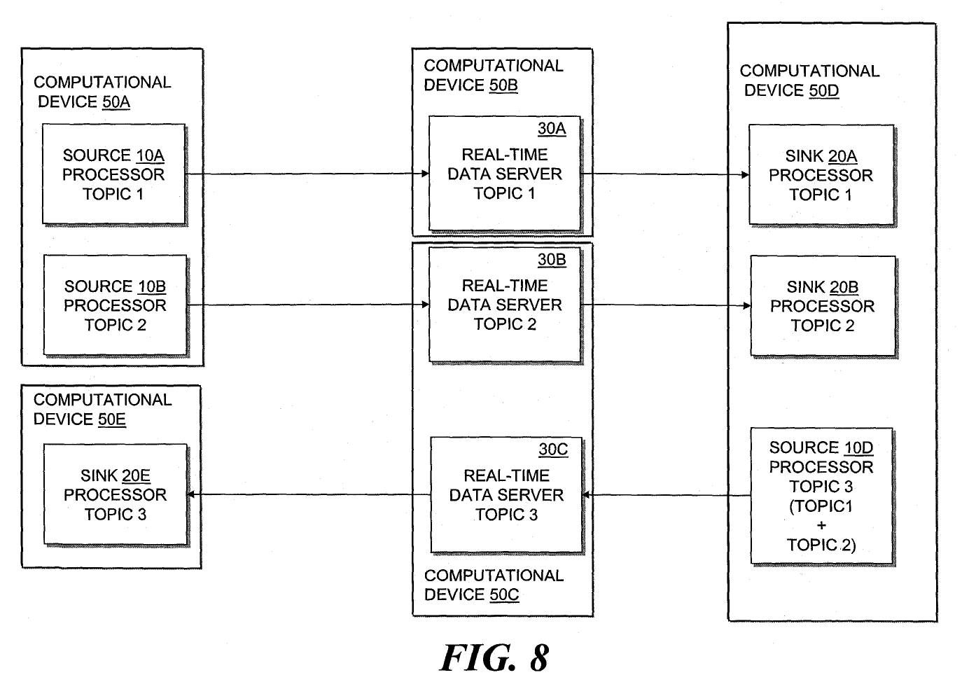

With reference to FIG. 8, the present invention can be configured to provide data filtering and data aggregation capabilities. In an illustrative example, a computational device 50A hosts a source processor 10A dedicated to topic 1 and a source processor 10B dedicated to topic 2. A computational device 50B hosts real-time data server 30A. A computational device 50C hosts real-time data servers 30B and 30C. A computational device 50D hosts a sink processor 20A that is dedicated to topic 1, a sink processor 20B that is dedicated to topic 2, and a source processor 10D dedicated to topic 3. The source processor 10D combines both topic 1 and topic 2 to create topic 3. A computational device 50E hosts sink processor 20E, which is in communication with the real-time data server 30C. The communication relationships are established via a match-maker processor 60 (not shown), as described in connection with FIGS. 2 and 3.

In operation, the source processors transmit topic 1 and topic 2 to their respective real-time data servers 30A and 30B. The servers, in turn, disseminate the topics to the sink processors 20A and 20B. The source processor 10D aggregates topic 1 and topic 2 to create topic 3. Sink processor 20E receives the aggregated topic 3 from real-time data server 30C, as described in FIG. 4. As such, a single connection between the sink processor 20E and real-time data server 30C facilitates the transfer of topics 1 and 2, obviating the need to establish a connection with the real-time data servers 30A and 30B.

Alternatively, topic 3 can be broken down into two individual topics (i.e., topics 1 and 2) by two sink processors. The two topics can be transferred individually to two respective real-time data servers by respective source processors. The two topics can then be disseminated individually to sink processors configured to receive only topic 1 or topic 2. As such, data filtering can be achieved.

By way of example, FIGS. 9A-9F depict an example data transfer from a source processor 10 (FIGS. 9A and 9B) to a real-time data server 30 (FIGS. 9C and 9D), and, in turn, to a sink processor 20 (FIGS. 9E and 9F), as described in FIG. 4. A match-maker processor 60 establishes communication among the source processor 10, sink processor 20, and real-time data server 30. FIG. 9A depicts three rows of a worksheet that are part of a workbook of a spreadsheet application. Although a spreadsheet application is shown, other office productivity software application alone or in combination may be used without departing from the spirit and scope of the present invention. The worksheet represents a data topic, and each row represents an item of the topic. More specifically, row one represents item one, row two represents, item two, and row three, item three. In this example, certain parameters, such as, frequency, bandwidth, and gain, of three receivers are controlled. Initially, with reference to FIG. 9A, the gain of receiver 1 is set to 0 dB at a source processor 10. In FIG. 9B, the gain of receiver 1 is changed, either manually or automatically, to 6 dB at the source processor 10. A software button labeled “Tune” is executed, either by a user or automatically, to invoke a real-time data transfer to the real-time data server 30. The parameters of item one are transferred into internal memory of the computational device hosting the source processor 10. Optionally, additional data validation may be performed on the data at the source processor 10. The parameters of item one are transformed into a comma-separated or alternatively any delimited string of values. In this example, the string is “91.1,5,6.” The string is sent to the real-time data server 30, along with the item number for proper identification by the real-time data server 30.

The real-time data server 30 allocates a buffer to hold a maximum number of items for the topic. The real-time data server 30 was previously informed of the maximum number of items that are related to the topic by the match-maker processor 60. The real-time data server 30 also maintains a collection of registered sink processors 20 and the items of the topic it expects to receive. The real-time data server 30 receives the request to send the data from the source processor 10. The request identifies which item of the topic has changed and the concatenated string of parameters. The real-time data server 30 queues the received request, and replaces the current item one (FIG. 9C) with the received string. The results are shown in FIG. 9D. The parameter values are stored in the internal memory of the host of the real-time data server 30. The real-time data server 30 notifies each of the registered sink processors 20 that the item of the topic that has been updated.

The sink processors 20 that are registered to receive the item of the topic that has changed receive the notification from the real-time data server 30. In response, the sink processors 20 retrieve (pull) the updated information from the real-time data server 30. Alternatively, the updated information is transmitted (pushed) to the sink processors 20. In one embodiment, the updated information is a two dimensional array that includes the item number and the string. FIG. 9E depicts a worksheet located on the computational device hosting the sink processor 20 after the sink processor has received the updated information. The updated information is transferred from internal memory of the host of the sink processor into a cell of the worksheet. The cell is part of a column labeled “String,” which is typically not viewable. In one embodiment, such a transfer may be accomplished using a custom function created using EXCEL. Such a custom function can be invoked in the worksheet cell of an EXCEL workbook using a formula such as “=FUNCTIONNAME (ITEM NUMBER).” Custom formulas in the parameter cells of the worksheet (i.e., Frequency, Bandwidth, and Gain) split the received string into individual cell values. The updated parameters are transferred into the appropriate cells, thereby updating the sink processor 20 in real-time.

Having shown the preferred embodiments, one skilled in the art will realize that many variations are possible within the scope and spirit of the claimed invention. It is therefore the intention to limit the invention only by the scope of the claims.

What is claimed is:

1. A method of facilitating real-time data distribution and collection among office productivity software applications running on each of a plurality of source and destination processors communicating over a distributed data processing network through a real-time server, the method comprising the steps of:
receiving, at the real-time server, data related to a first topic from the office productivity software processing application running on one or more of the source processors; and
disseminating in real-time, via the first real-time server, data related to the first topic to the office productivity software application running on one or more of the destination processors.

2. The method of claim 1, wherein the step of disseminating comprises retrieving the data related to the first topic from the first real-time server by the destination processors.

3. The method of claim 1, wherein the step of disseminating comprises transmitting the data related to the first topic to the destination processors.

4. The method of claim 1 further comprising the step of queuing at least one of:
(i) the data related to the first topic, and
(ii) requests to receive the data related to the first topic.

5. The method of claim 1, wherein the step of providing a first real-time server comprises:
dynamically selecting a processor from one of a plurality of processors to host the first real-time server; and
initializing the first real-time server on the dynamically-selected host processor.

6. The method of claim 5, wherein the step of dynamically determining the host comprises determining the processor within the plurality of processors that has the lowest processing load.

7. The method of claim 1, wherein the office productivity software application is selected from the group consisting of a spreadsheet application, a word processing application, and a database application.

8. The method of claim 1 further comprising the step of notifying each destination processor that data related to the first topic has been received by the real-time server.

9. The method of claim 8 further comprising the step of periodically notifying the destination processor that the data related to the first topic has been received when the received data has not been disseminated to the destination processor.

10. A method of facilitating real-time data distribution and collection among office productivity software applications running on each of a plurality of processors communicating over a distributed data processing network, the method comprising the steps of:
receiving a request for a reference identifier of a real-time data server dedicated to a first topic from a first processor;
initiating a real-time data server on a host processor for the first topic;
receiving a request for a reference identifier of a real-time data server dedicated to a second topic from a second processor;
comparing the request for a reference identifier of a real-time data server dedicated to the first topic to the request for a reference identifier of a real-time data server dedicated to the second topic; and
facilitating communication of data related to the first topic between the first processor and second processor via the real-time data server dedicated to the first topic when the second topic corresponds to the first topic.

11. The method of claim 10, wherein the initiating step occurs in response to the step of receiving the request for a reference identifier of a real-time data server dedicated to the first topic.

12. The method of claim 10, wherein the initiating step occurs in response to the step of receiving the request for a reference identifier of a real-time data server dedicated to the second topic.

13. The method of claim 10, wherein the step of initializing a server on a host processor comprises:
dynamically selecting a processor with the lowest processing load from a plurality of processors to host the real-time data server; and
initiating the real-time data server on the dynamically-selected host processor.

14. The method of claim 13, further comprising the steps of:
transmitting an identifier of the dynamically-determined host processor to the first processor; and
transmitting the identifier of the dynamically-determined host processor to the second processor.

15. The method of claim 10, wherein the step of facilitating communication of data comprises:
receiving data related to the first topic from the office productivity software application running on the first processor at the real-time data server;
notifying the second processor that data related to the first topic has been received; and
disseminating the received data to the second processor.

16. The method of claim 17, wherein the step of disseminating comprises:
retrieving, by the second processor, the received data from the real-time data server; or
transmitting, by the real-time server, the received data to the second processor.

17. The method of claim 10, wherein the first processor and the second processor run on a same computational device.

18. The method of claim 10, wherein the office productivity software application is selected from the group consisting of a spreadsheet application, a word processing application, and a database application.

19. A method of facilitating real-time data distribution and collection among a plurality of office productivity software applications running on a each of a plurality of source and destination processors and communicating over a distributed data processing network, the method comprising the steps of:
initializing a real-time server on a dynamically-determined host processor;
transmitting an identifier of the dynamically-determined host processor to each source and destination processor requesting a reference identifier to the real-time server; and
receiving data at the real-time server transmitted by the one or more source processors requesting the reference identifier;
disseminating the data from the real-time server to each of the destination processors that requested the reference identifier, thereby updating the office productivity software applications running on the destination processors in real-time.

20. The method of claim 19 further comprising the step of notifying each of the destination processors that requested the reference identifier to the real-time server that data related to the specific topic has been received by the real-time server.

21. The method of claim 19 further comprising the step of queuing the received data or requests to receive the data by the real-time server.

22. The method of claim 19, wherein the step of disseminating comprises retrieving, by each destination processor, the received data from the real-time data server.

23. The method of claim 19, wherein the step of disseminating comprises transmitting, by the real-time server, the received data to each destination processor.

24. A method of facilitating real-time data distribution and collection among a plurality of software applications communicating over a distributed data processing network through a real-time server, the method comprising the steps of:
receiving, at the real-time server, data related to a first topic from one or more of the software applications; and
disseminating in real-time, via the first real-time server, data related to the first topic to one or more software application.
